(19) United States
(12) Patent Application Publication
(10) Pub. No.: US 2015/0058870 A1
(43) Pub. Date: Feb. 26, 2015

(54) FACILITATING PURCHASE FROM VIDEO ADVERTISEMENTS

(71) Applicants: Ramaneek Khanna, Saratoga, CA (US); Geoffrey W. Chatterton, Santa Clara, CA (US); Timothy C. Nichols, Los Altos, CA (US)

(72) Inventors: Ramaneek Khanna, Saratoga, CA (US); Geoffrey W. Chatterton, Santa Clara, CA (US); Timothy C. Nichols, Los Altos, CA (US)

(21) Appl. No.: 13/975,191

(22) Filed: Aug. 23, 2013

(51) Int. Cl. H04N 21/254; H04N 21/478; H04N 21/81

(52) U.S. Cl. CPC H04N 21/2542; H04N 21/812; H04N 21/47815
USPC 725/5; 725/1

(57) ABSTRACT

A purchase code, such as a web address indicating a webpage of a product at a merchant's website, may be embedded into a video advertisement by steganography. The video advertisement embedding the purchase code may be displayed to consumers on televisions or on display kiosks installed at a merchant's storefront. A consumer, who is viewing the video advertisement and is interested in purchasing the product being advertised, may point a mobile device with a camera, e.g., a smart phone, to scan the video advertisement with the camera. The mobile device may decode the video advertisement to capture the purchase code embedded in the video advertisement. The purchase code may automatically direct the mobile device to visit the product web page at the merchant's web site. Thus, the consumer may purchase the product immediately at the merchant's web site.

### BACKGROUND

1. Field of the Invention

The present invention generally relates to systems and methods that facilitate product purchases from video advertisements.

2. Related Art

Video advertisements are popular options for merchants to advertise their products on a television, a kiosk installed at a brick-and-mortar store, a display in public places, such as movie theaters, or the like. Video advertisements typically introduce products to consumers and attempt to entice consumers to purchase the products. Some video advertisements provide contact information, such as a telephone number or a web address, by which a consumer can contact the merchant or the merchant's web site to purchase the product being advertised. If the consumer wishes to purchase the advertised product, the consumer needs to remember the telephone number or web address listed in the video advertisement and use a telephone or a computer to call the merchant or visit the merchant's website. However, consumers who fail to remember the contact information of the merchant are not able to make a purchase. Further, these additional steps for contacting the merchant may discourage some consumers from making a purchase. Thus, there is a need for a system or method that seamlessly facilitates the process of making a purchase from a video advertisement.

### BRIEF DESCRIPTION OF THE FIGURES

FIG. 1A is block diagram of a networked system suitable for implementing a process for facilitating purchases from video advertisements according to an embodiment.

FIG. 1B is diagram illustrating interactions between a user device and a video advertisement according to an embodiment.

FIG. 2 is a flowchart showing a process for encoding a purchase code into a video advertisement according to one embodiment.

FIG. 3 is a flowchart showing a process for decoding a purchase code from a video advertisement according to one embodiment.

FIG. 4 is a block diagram of a computer system suitable for implementing one or more components in FIGS. 1A and 1B according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, a purchase code, such as a web address that indicates a webpage of a product offered for sale at a merchant's website, may be embedded into a video advertisement by steganography. As used herein, products refer to physical goods, digital goods, services, donations, and other things a consumer may make a payment for. The video advertisement embedded with the purchase code may be displayed to consumers on a television or a display kiosk at a merchant's storefront. A consumer, who is viewing the video advertisement and is interested in purchasing the product being advertised, may point a mobile device with a built-in camera, e.g., a smart phone, to scan the video advertisement with the camera. The mobile device may decode the video advertisement to extract the purchase code embedded in the video advertisement. The purchase code may automatically direct the mobile device to visit the product web page at the merchant's web site. Thus, the consumer may purchase the product immediately at the merchant's web site. Further, because the purchase code is embedded in the video advertisement by steganography, the purchase code may be hidden from the consumers without distracting the consumers from viewing the video advertisement.

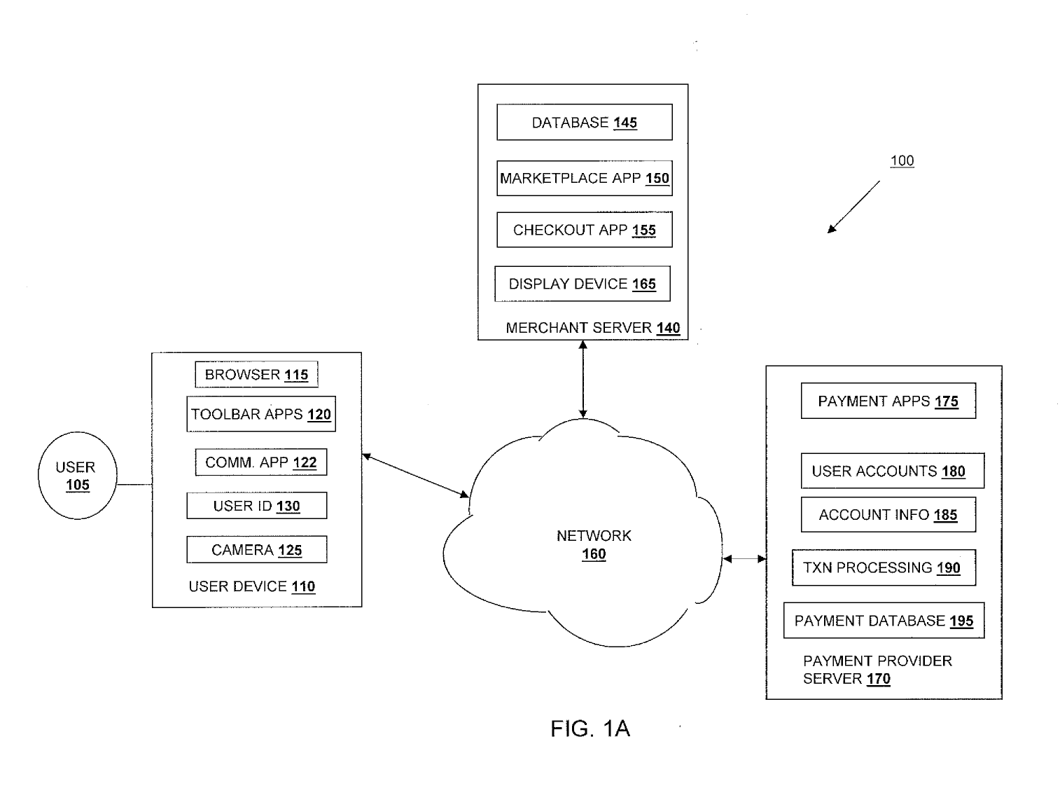

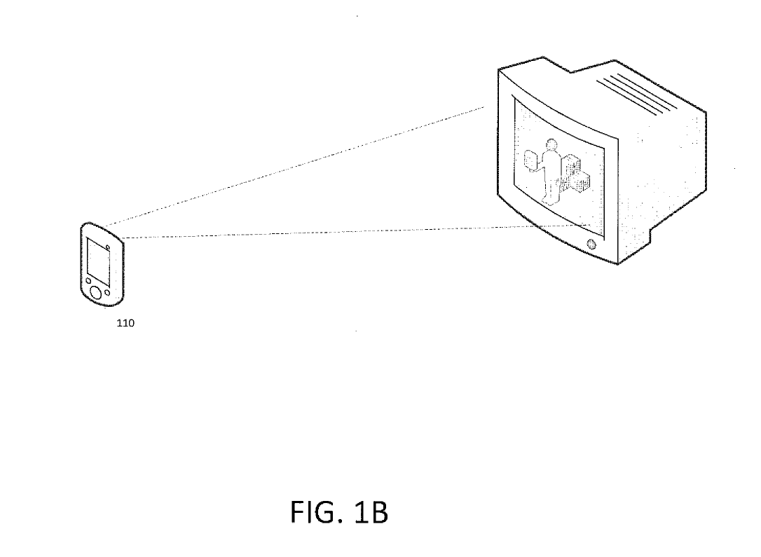

FIG. 1A is a block diagram of a networked system 100 configured to implement a process for facilitating purchases from video advertisements in accordance with an embodiment of the invention. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant server 140, and a payment provider server 170 in communication over a network 360. Payment provider server 170 may be maintained by a payment service provider, such as PayPal, Inc. of San Jose, Calif. A user 105, such as a consumer, may utilize user device 110 to perform a purchase transaction using payment provider server 170. A user 105 may utilize user device 110 to visit a merchant's web site provided by merchant server 140 to browse for products offered by the merchant. Further, user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing products from multiple merchants.

User device 110, merchant server 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include a camera 125 configured to capture pictures or videos. For example, camera 125 may be used to capture a video advertisement displayed on a television or a display kiosk. Camera 125 may include image sensors and processors for image processing.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a smart wallet through the payment provider as discussed above.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

Merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be a donation to charity. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 360 to browser 115 of user device 110. In one embodiment, user 105 may interact with marketplace application 150 through browser applications over network 160 in order to view various products, food items, or services identified in database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment service provider server 170 over network 160. For example, checkout application 155 may receive and process a payment confirmation from payment service provider server 170, as well as transmit transaction information to the payment provider and receive information from the payment provider (e.g., a transaction ID).

Checkout application 155 may be configured to receive payment via a plurality of payment methods including cash, credit cards, debit cards, checks, money orders, or the like. The merchant server 140 may also include a display device 165 for displaying information to a user or a consumer. In one embodiment, display device 165 may be connected to merchant server 140 via a wire line or wireless communication means. Display device 165 may receive display information from merchant server 140 and may display product information, such as product advertisement. For example, merchant server 140 may forward a product advertisement embedded with a purchase code to display device 165. Display device 165 then may display the product advertisement to consumers.

Payment provider server 170 may be maintained, for example, by an online payment service provider which may provide payment between user 105 and the operator of merchant server 140, In this regard, payment provider server 170 may include one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, user names, phone numbers, credit card information, bank information, or other financial information which may be used to facilitate online transactions by user 105. Account information may also include user purchase history and user ratings. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

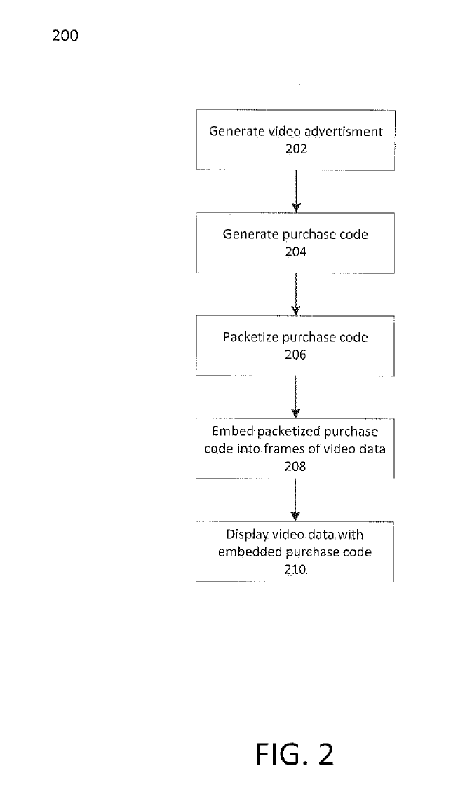

FIG. 2 is a flowchart showing a process 200 for encoding a purchase code into a video advertisement according to one embodiment. At step 202, a video advertisement for the product may be generated. The video advertisement may be a product advertisement to be displayed on any suitable display device, such as a television or on a display kiosk at a merchant's store front, a video screen at a public location such as a gas pump, a PC, a computing tablet, or a smart phone. The video advertisement may introduce the product and may entice customers to purchase the product. In one embodiment, the video advertisement may be a video, e.g., a television show or a movie, that has product placements. For example, a merchant may pay for a product to be placed in a television show or a movie. Thus, viewers of the television show or the movie may be presented with the product in a subtle manner. The video advertisement may be made by the merchant or by a third party hired by the merchant. The video advertisement may be recorded in analog or digital formats and formed by a plurality of still images. For example, the video advertisement may have thirty frames of still images per second. The plurality of still images may be displayed consecutively to depict a moving picture.

At step 204, a purchase code may be generated for purchasing a product offered by a merchant. The purchase code may be a web address including a Uniform Resource Locator (URL) of merchant server 140 of the merchant. In particular, the purchase code may include an URL of a web page presenting the product advertised by the video advertisement. In one embodiment, the purchase code may be an URL directing to a program at checkout application 155 of merchant server 140. The program may allow the consumer to immediately purchase and pay for the product. In another embodiment, the purchase code may be an executable instruction that executes a purchase or payment application at user device 110. For example, the purchase code may activate an application that connects user device 110 to merchant server 140 or to payment provider server 170. Thus, a purchase transaction between user device 110 and merchant server 140 or payment provider server 170 may be initiated to purchase the product.

In still another embodiment, the purchase code may be a unique identifier of the product, such as a Universal Product Code (UPC), QR code, bar code, or a product description or model number. User device 110 or payment provider server 170 may read the product's unique identifier and find a list of merchants, both online and brick-and-mortar stores, that offer the product for sale. For example, a list of brick-and-motor stores that offer the product for sale and are located near user device 110 may be identified.

At step 206, the purchase code may be packetized. For example, the purchase code may be a data string and may be divided into a plurality of data packets. Each data packet may be labeled with a counter to indicate the order of the packets in the data string. For example, a data packet may have a counter that indicates that the data packet is the 21^{st} of 60 packets. Further, error correction process may be implemented for each data packet. For example, a forward error correction may be implemented to add redundancy to the data packets in order to control errors that occurred in a data transmission.

At step 208, the data packets generated from the purchase code may be encoded into the video advertisement. In particular the purchase code may be embedded in the video advertisement using steganography, such that the embedded purchase code is hidden from the consumer and does not interfere with consumer's viewing of the video advertisement. Steganography may be used to hide the embedded purchase code from human eyes, such that the consumers viewing the video advertisement are not distracted by the embedded purchase code.

Various types of image steganography may be implemented to encode the purchase code into the video advertisement. For example, a wavelet based steganography may be used to encode the data packets of the purchase code into respective frames of the video advertisement. The wavelet based steganography may use discrete wavelet transform (DWT) to convert an image from a spatial domain into a frequency domain. The data packets of the purchase code may be hidden in the transform coefficients of the image. Thus, wavelet based steganography may allow the embedded purchase code to survive data compression or filtering. Other methods, such as Discrete Cosine Transform (DCT), Fast Fourier Transform (FFT), Least Significant Bit (LSB) insertion, patchwork, or spread spectrum, also may be utilized to embed the data packets into respective frames of the video advertisement.

Each frame of the video advertisement may be embedded with one data packet of the purchase code. Based on the frame rate of the video advertisement and the capturing frame rate of a consumer's camera, each data packet may be repeated in multiple consecutive frames of the video advertisement. For example, if the video advertisement is displayed at a frame rate of 30 frames/second and the capturing camera captures at a frame rate of 25 frames/second, some of the frames of the video advertisement may not be captured by the capturing camera. Further, the video advertisement may be displayed at a lower frame rate than the original frame rate of the video advertisement. Thus, some frames of the original video advertisement may not be displayed to the consumers. In order to ensure that all of the data packets of the purchase code are displayed and captured by the capturing camera, each data packet of the purchase code may be repeated in multiple consecutive frames of the video advertisement. For example, the same data packet may be embedded into two or three consecutive frames.

The embedded purchase code may continuously be cycled through the entire length of the video advertisement for multiple times. For example, if the data packets of the purchase code occupy 90 frames or three seconds of the video advertisement, the purchase code may be repeated every three seconds for the entire length of the video advertisement. Thus, a consumer may capture the purchase code at any time when the video advertisement is displayed.

In one embodiment, multiple purchase codes for multiple products may be embedded in a video advertisement. For example, a video, e.g., a movie or a television show, may have multiple product placements. The products may be displayed at different positions on the screen. The purchase code of a product may be embedded in a position of the screen corresponding to the display position of the product on the screen. For example, the position of the screen may be defined using an x-y coordinate. If a pair of boots are displayed around coordinate [100, 200] on the screen, the purchase code for purchasing the pair of boots may be embedded around coordinate [100, 200] of the screen. Thus, when a user wishes to purchase the pair of boots, the user may scan the area around coordinate [100, 200] of the screen where the pair of boots are displayed to capture the purchase code. Further, different products may be displayed simultaneously in different positions of the screen and their corresponding purchase codes may be embedded in their corresponding display positions. In another embodiment, different purchase codes for different products may be embedded into the video with time offset.

At step 210, the video advertisement embedded with the purchase code may be displayed to consumers on a television or on a display kiosk at a storefront or other suitable display devices. For example, the video advertisement may be sent to a television station to be displayed as a television advertisement. The video advertisement also may be sent to a merchant's store or location to be displayed on a display 165 installed at the merchant's store or location. The video advertisement also may be embedded in an interne web site to be displayed on computers, mobile devices, and the like.

By using the above process, a purchase code for purchasing a product may be embedded into a video advertisement. Further, the purchase code may be hidden in the video advertisement using steganography, such that the purchase code does not interfere with the consumer's viewing of the video advertisement.

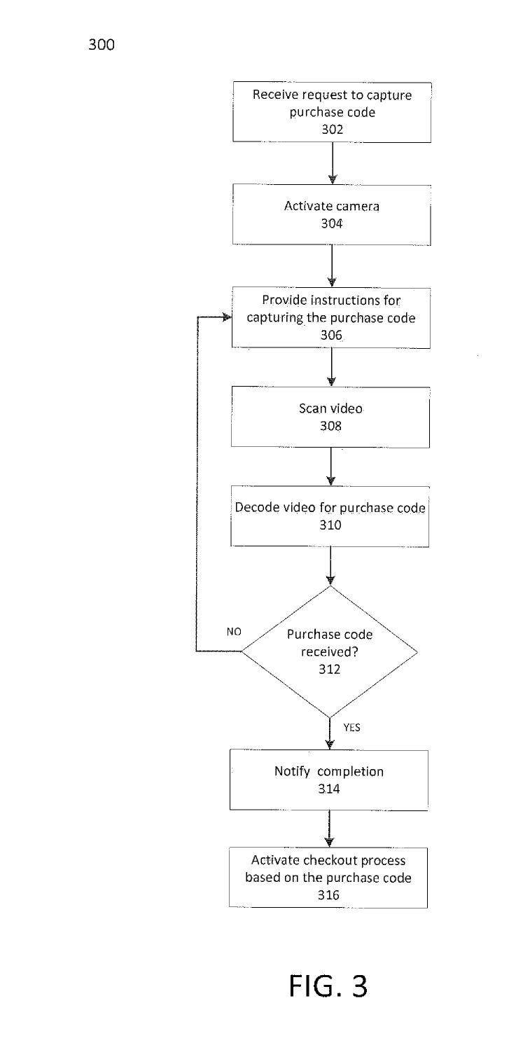

FIG. 3 is a flowchart showing a process 300 for reading and decoding a purchase code from a video advertisement according to one embodiment. At step 302, user device 110 may receive a request to capture a purchase code from a video advertisement. For example, as shown in FIG. 1B, when a consumer is viewing a video advertisement on a television, the consumer may wish to purchase the product being advertised. The consumer may activate an application on user device 110 to capture a purchase code embedded in the video advertisement.

User device 110 may receive the user input and begin to activate camera 125 of user device 110 at step 304. At step 306, user device 110 may instruct the user how to capture the purchase code from the video advertisement. For example, user device 110 may have a display screen that displays information instructing the user to point and hold camera 125 of user device 110 toward the video advertisement, such as placing the video within a designated border or box. The display screen of user device 110 may display a moving picture of what is being capture by camera 125 of user device 110.

At step 308, camera 125 of user device 110 may capture the video advertisement. For example, when the camera 125 is pointed at the video advertisement, the display of user device 110 may display the captured video advertisement in real time. A bracket or box may overlay the captured video advertisement and user device 110 may instruct the user to adjust the position of user device 110 such that the video advertisement is captured within the overlay bracket or box.

At step 310, user device 110 may decode the captured video advertisement to extract the purchase code embedded in the video advertisement. For example, images from each frames of the captured video advertisement may be processed and decoded to extract the data packets embedded in the frames using steganography techniques, as noted in step 208. The extracted data packets may be rearranged based on the counters labeled on each of the data packets. Based on the counters, user device 110 may determine whether all of the data packets of the purchase code are received at step 312. For example, the counters may indicate that a total of 50 data packets are embedded in the video advertisement. Further, each data packet may be labeled with a unique counter number, such as 3 of 50 or 39 of 50, and the like. Thus, user device 110 may determine whether all of the data packets have been received, and if not, which data packet is missing.

If user device 110 determines that certain data packets are missing at step 312, user device 110 may provide instructions to further capture the purchase code at step 306 in order to capture the missing data packet. For example, user device 110 may instruct the user to continue scanning the video advertisement or to scan the video advertisement again. If user device 110 determines that all of the data packets for the purchase code have been received at step 312, user device 110 may notify the user that the scanning is complete at step 314.

At step 316, user device 110 may arrange the data packets based on the order indicated in the counters to form the purchase code. As noted above, the purchase code may be a web address of the product page at the merchant's web site. User device 110 may visit the product page at the merchant's web site using the web address provided by the purchase code. In one embodiment, the purchase code may be a unique identifier, e.g., UPC number, of the produce being advertised. User device 110 may have an application that searches for merchants, e.g., online or brick-and-mortar merchants, that offer the product for sale using the UPC number of the product. User device 110 may provide a list of merchants for the user to choose from to purchase the product.

In another embodiment, the purchase code may be an execution code for activating a payment application on user device 110. User device 110 may activate the payment application to connect to payment provider server 170 to begin a checkout process for purchasing the product at step 316.

In one embodiment, processing of the embedded purchase code may be performed by payment provider server 170 instead of user device 110. For example, once the video advertisement is captured by user device 110, the video advertisement may be communicated electronically to payment provider server 170 for processing (similar to user device processing described above) the video advertisement to extract the embedded purchase code. Based on the purchase code, payment provider server 170 may send information, such as a URL, link, or display that enables the user to purchase and pay for the product advertised in the video advertisement. In another embodiment, after user device 110 captures the video advertisement, user device 110 may initiate processing and then communicate information to payment provider server 170 to complete the processing. As such, processing may be allocated between user device 110 and payment provider server 170 in any suitable fashion.

After viewing the product web page, the user may use user device 110 to send a confirmation for purchasing the advertised product to payment provider server 170. Payment provider server 170 may then debit a purchase amount from the user's payment account and credit the purchase amount to the merchant's account. Payment provider server 170 may confirm the purchase and payment with the merchant. The merchant may then proceed to send the advertised product to the user.

By using the above process, user experience for purchasing a product advertised in a video advertisement may be improved. In particular, the consumer may scan the video advertisement using a mobile device and may purchase and pay for the product advertised on the video advertisement using the same mobile device, without additional effort or delay. Further, the purchase code for the product may be embedded in the video advertisement using steganography. Thus, the consumer may not be distracted by the purchase code when viewing the video advertisement.

The following are exemplary situations in which the above processes for facilitating purchase from video advertisements may be implemented.

### EXAMPLE 1

A consumer is viewing a television advertisement, such as an infomercial, advertising a widget. A salesperson in the television advertisement is presenting the widget and enticing viewers to purchase the widget. In particular, the salesperson encourages viewers to purchase the widget immediately by scanning their television screen with a camera of a smart phone. The consumer is interested in purchasing the widget. The consumer points a camera of a mobile phone to scan the video advertisement being displayed on the television.

The mobile device scans the video advertisement for several seconds and makes a beep sound to indicate that the scanning is complete. The mobile device decodes the captured video advertisement to extract the hidden purchase code embedded in the video advertisement using steganography. The purchase code is an. UPC number of the widget. The mobile device uses the UPC number to search for both online merchants and nearby brick-and-mortar merchants that offer the widget for sale. The mobile device may include information, such as price and availability of the widget, with the list of merchants. The consumer may select a merchant from the list and purchase or order the widget from the selected merchant using the mobile device. Thus, the consumer may purchase the widget without having to remember the name of the widget or the telephone number of the merchant, and without having to make a phone call.

### EXAMPLE 2

A consumer is vising a shopping center and is walking by a merchant's store that sells widgets. The merchant's store has a display screen showing a video advertising widgets to shoppers walking by the store. The consumer stops in front of the merchant's store to view the video advertisement. The consumer is interested in purchasing the widget. Following the instructions given on the video advertisement, the consumer scans the video advertisement using a camera included on the consumer's mobile phone. The mobile phone decodes the captured video advertisement to extract a purchase code for purchasing the widget. The purchase code is a web address for a widget product page at the merchant's web site. The consumer uses the mobile device to purchase the widget at the merchant's web site. The consumer chooses to pick up the widget at the store. After paying for the widget using the mobile phone, the consumer enters the merchant's store to pick up the widget from the store. Thus, the consumer is able to purchase and pay for the widget using the mobile phone before picking up the widget from the store.

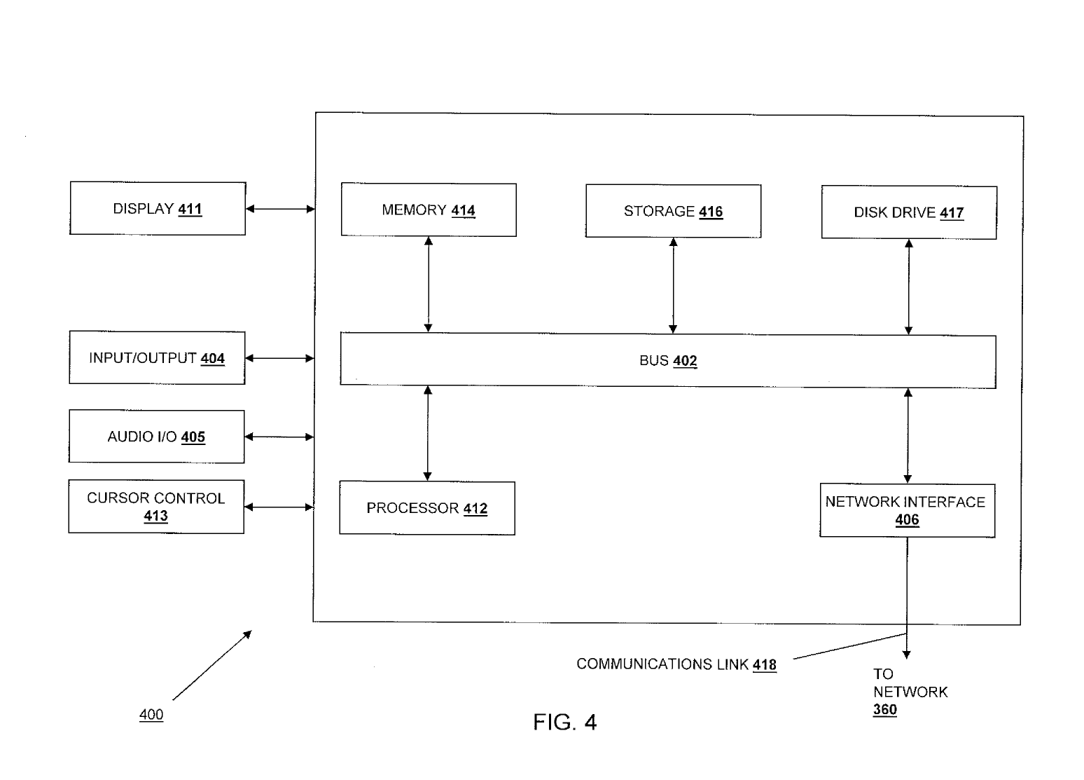

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system for facilitating purchase transactions, the system comprising:
one or more processors adapted to:
receive a video advertisement, in which a purchase code is embedded by steganography for purchasing a product advertised in the video advertisement;
decode the video advertisement to capture the embedded purchase code; and
activate the purchase code to facilitate a purchase transaction for purchasing the advertised product.

2. The system of claim 1, wherein the step of receiving a video advertisement comprises:
activating a camera of a mobile device; and
scanning the video advertisement with the camera of the mobile device.

3. The system of claim 1, wherein the step of decoding the video advertisement comprises:
capturing frames of the video advertisement;
decoding each of the frames of the video advertisement to extract data packets of the purchase code, which are encoded into the frames of the video advertisement by steganography; and
arranging the data packets by a counter labeled on each data packet to form the purchase code.

4. The system of claim 1,
wherein the purchase code is a web address of a product page for purchasing the advertised product; and
wherein the step of activating the purchase code comprises requesting the product page for purchasing the advertised product based on the purchase code.

5. The system of claim 1,
wherein the purchase code is an executable code for a payment application on the mobile device; and
wherein the step of activating the purchase code comprises activating the payment application to connect the mobile device to a payment service provider to purchase and pay for the advertised product.

6. The system of claim 1,
wherein the purchase code is an unique identifier of the advertised product; and
wherein the step of activating the purchase code comprises searching for a merchant who offers the advertised product for sale based on the unique identifier of the advertised product.

7. The system of claim 1, wherein the purchase code is embedded in the video advertisement using transform domain steganography.

8. The system of claim 1, wherein the camera scans the video advertisement at a frame rate less than a display frame rate of the video advertisement.

9. The system of claim 3, wherein the purchase code is embedded in a portion of the frame corresponding to a display position of the advertised product.

10. The system of claim 3, wherein a plurality of purchase codes corresponding to a plurality of products are embedded in the frame of the video advertisement.

11. A method for facilitating purchase transactions comprising:
receiving a video advertisement, in which a purchase code is embedded by steganography for purchasing a product advertised in the video advertisement;
decoding the video advertisement to capture the embedded purchase code; and
activating the purchase code to facilitate a purchase transaction for purchasing the advertised product.

12. The method of claim 11, wherein the step of receiving a video advertisement comprises:
activating a camera of a mobile device; and
scanning the video advertisement with the camera of the mobile device.

13. The method of claim 11, wherein the step of decoding the video advertisement comprises:
capturing frames of the video advertisement;
decoding each of the frames of the video advertisement to extract data packets of the purchase code, which are encoded into the frames of the video advertisement by steganography; and
arranging the data packets by a counter labeled on each data packet to form the purchase code.

14. The method of claim 11,
wherein the purchase code is a web address of a product page for purchasing the advertised product; and
wherein the step of activating the purchase code comprises requesting the product page for purchasing the advertised product based on the purchase code.

15. The method of claim 11,
wherein the purchase code is an executable code for a payment application on the mobile device; and
wherein the step of activating the purchase code comprises activating the payment application to connect the mobile device to a payment service provider to purchase and pay for the advertised product.

16. The method of claim 11,
wherein the purchase code is an unique identifier of the advertised product; and
wherein the step of activating the purchase code comprises searching for a merchant who offers the advertised product for sale based on the unique identifier of the advertised product.

17. The method of claim 11, wherein the purchase code is embedded in the video advertisement using transform domain steganography.

18. The method of claim 11, wherein the camera scans the video advertisement at a frame rate less than a display frame rate of the video advertisement.

19. A system for facilitating purchase transactions, the system comprising:
a memory storing information for a payment account of a user;
one or more processors in communication with the memory adapted to:
receive, from a user device associated with the user, a video advertisement, in which a purchase code is embedded by steganography for purchasing a product advertised in the video advertisement;
decode the video advertisement to capture the embedded purchase code; and
send information associated with a purchase transaction to the user device to enable the user to purchase the advertised product based on the embedded purchase code.

20. The system of claim 19, wherein the one or more processors is further adapted to:
receive a request from the user device for purchasing the advertised product based on the purchase code;
initiate a purchase transaction for purchasing the advertised product using the payment account of the user; and
process the purchase transaction by debiting a purchase amount from the payment account of the user and crediting a merchant account of a merchant from whom the advertised product is purchased.
